(19) United States
(12) Patent Application Publication
(10) Pub. No.: US 2023/0243377 A1
(43) Pub. Date: Aug. 3, 2023

(54) LOCKING ARRANGEMENTS FOR FURNITURE COMPONENTS

(71) Applicant: POPPIN, INC., New York, NY (US)

(72) Inventors: Jeffrey F. MILLER, New York, NY (US); Adrian GOMEZ, Edgewater, NJ (US); William COWLES, Long Island City, NY (US); David STRAUSS, Tarrytown, NY (US)

(73) Assignee: POPPIN, INC., New York, NY (US)

(21) Appl. No.: 17/995,996

(22) PCT Filed: Apr. 18, 2020
(86) PCT No.: PCT/US2020/028886

§ 371 Date: Oct. 12, 2022

(51) Int. Cl. F16B 12/10; F16B 21/04; A47B 13/02

(52) U.S. Cl. CPC F16B 12/10; F16B 21/04; A47B 13/021

(57) ABSTRACT

An assembly comprising a first furniture component and a second furniture component is disclosed. The first furniture component comprises a spring-loaded detent. The spring-loaded detent is biased axially along a central axis toward a locked configuration. The second furniture component comprises a lock arrangement. The first furniture component and the second furniture component are rotatably connected about the central axis through a rotary range of motion. The lock arrangement is configured to move the spring-loaded detent from the locked configuration to an unlocked configuration during the rotary range of motion, release the spring-loaded detent from the unlocked configuration after the rotary range of motion, and prevent rotation of the spring-loaded detent in the locked configuration after the rotary range of motion.

### FIELD

The present disclosure relates to locking arrangements for furniture components.

### BACKGROUND

Furniture that is easy to assemble and disassemble can be convenient for purchasing, shipping, relocating, rearranging, and/or selling the furniture.

### SUMMARY

In various aspects, an assembly comprising a first furniture component and a second furniture component is disclosed. The first furniture component comprises a socket. The socket comprises a receptacle, a lock, and a nub extending into the receptacle. The first furniture component and the second furniture component are movable between an unassembled configuration and an assembled configuration. The second furniture component comprises a plug configured to fit at least partially within the receptacle when the first furniture component and the second furniture component are in the assembled configuration. The plug comprises a body and a spring-loaded plunger. The body comprises a cavity, an outer surface, and a guide slot in the outer surface. The guide slot is configured to receive the nub as the first furniture component and the second furniture component are moved into the assembled configuration. The spring-loaded plunger is configured to fit at least partially within the cavity. The spring-loaded plunger is configured to move axially but not rotatably relative to the body. The lock is configured to compress the spring-loaded plunger within the cavity from a first configuration to a second configuration as the plug rotates within the receptacle and the nub moves along an engagement portion of the guide slot. The lock is configured to release the spring-loaded plunger from the second configuration when the nub moves past the engagement portion of the guide slot. The lock is configured to prevent rotation of the plug relative to the receptacle when the spring-loaded plunger is in the first configuration and the first furniture component and the second furniture component are in the assembled configuration.

In various aspects, an assembly comprising a furniture leg and a furniture foot is disclosed. The furniture leg comprises a plug. The plug comprises a body, a spring, and a detent arrangement. The body comprises a cavity, an outer surface, and a guide slot in the outer surface. The spring is positioned in the cavity. The spring is deformable to move the detent arrangement axially relative to the body. The furniture foot comprises a socket. The socket comprises a receptacle configured to rotatably receive the plug, a nub extending into the receptacle, and a lock. The nub is configured to move along the guide slot when the receptacle rotatably receives the plug. The lock is configured to move the detent arrangement axially between an unlocked position and a locked position when the receptacle rotatably receives the plug and the nub moves along a portion of the guide slot. The lock is further configured to prevent rotation of the plug relative to the receptacle when the detent arrangement is in the locked position and the plug is fully seated in the receptacle.

In various aspects, an assembly comprising a first furniture component and a second furniture component is disclosed. The first furniture component comprises a spring-loaded detent. The spring-loaded detent is biased axially along a central axis toward a locked configuration. The second furniture component comprises a lock arrangement. The first furniture component and the second furniture component are rotatably connected about the central axis through a rotary range of motion. The lock arrangement is configured to move the spring-loaded detent from the locked configuration to an unlocked configuration during the rotary range of motion, release the spring-loaded detent from the unlocked configuration after the rotary range of motion, and prevent rotation of the spring-loaded detent in the locked configuration after the rotary range of motion.

### FIGURES

Features of various aspects are set forth with particularity in the appended claims. The described aspects, however, both as to organization and methods of operation, may be best understood by reference to the following description, taken in conjunction with the accompanying drawings.

FIG. 1 is a perspective view of a piece of furniture in an assembled configuration, in which a foot is assembled to each leg of the piece of furniture, in accordance with at least one aspect of the present disclosure.

FIG. 2 is a perspective view of the piece of furniture of FIG. 1, in which one of the feet is disassembled from the respective leg, in accordance with at least one aspect of the present disclosure.

FIG. 2A is a detail view of FIG. 2, depicting a plug at the end of the leg, in accordance with at least one aspect of the present disclosure.

FIG. 3 is an exploded perspective view of the plug of FIG. 2A, depicting a body, a spring, a plunger, a shaft, and an end cap of the plug, in accordance with at least one aspect of the present disclosure.

FIG. 4 is a plan view of the body of FIG. 3, in accordance with at least one aspect of the present disclosure.

FIG. 5 is an elevation view of the body of FIG. 3, in accordance with at least one aspect of the present disclosure.

FIG. 6 is a perspective cross-sectional view of the plug of FIG. 3 in an expanded configuration and with the end cap removed for clarity, in accordance with at least one aspect of the present disclosure.

FIG. 7 is a perspective cross-sectional view of the plug of FIG. 3 in a compressed configuration and with the end cap removed for clarity, in accordance with at least one aspect of the present disclosure.

FIG. 8 is a perspective view of one of the feet of FIG. 1, in accordance with at least one aspect of the present disclosure.

FIG. 8A is a detail view of FIG. 8, depicting a socket of the foot including locks and nubs thereof, in accordance with at least one aspect of the present disclosure.

FIG. 9 is a plan view of the foot of FIG. 8, in accordance with at least one aspect of the present disclosure.

FIG. 9A is a detail view of FIG. 9, depicting the socket of the foot including locks and nubs thereof, in accordance with at least one aspect of the present disclosure.

FIG. 10 is a plan view of the foot of FIG. 8 and the plunger and the spring of the plug of FIG. 3, in accordance with at least one aspect of the present disclosure.

FIG. 10A is a detail view of FIG. 10, in which the plunger and the spring of the plug are seated in the socket of the foot in a locked configuration relative to the locks of the socket, in accordance with at least one aspect of the present disclosure.

FIG. 11 is an elevation view of a portion of one of the legs and one of the feet of FIG. 1, in which the foot is transparent to reveal the plug seated in the socket of the foot, in accordance with at least one aspect of the present disclosure.

FIG. 12 is an elevation cross-sectional view of a portion of the leg and the foot of FIG. 11, in accordance with at least one aspect of the present disclosure.

FIG. 12A is a detail view of FIG. 12, in accordance with at least one aspect of the present disclosure.

FIG. 12B is another detail view of a portion of the leg and the foot of FIG. 12, in which the plug is in the compressed configuration to unlock the leg from the foot, in accordance with at least one aspect of the present disclosure.

FIG. 13 is a perspective view of the leg and the foot of FIG. 12 in an intermediate position, in which the foot is rotated such that the nubs are moved along the respective guide slots and the plunger is compressed relative to the body of the plug, in accordance with at least one aspect of the present disclosure.

FIG. 14 is a perspective view of the leg and the foot of FIG. 12 in an assembled position, in which the foot is further rotated from the orientation of FIG. 13 such that the nubs are moved to a final position in the respective guide slots and the plunger is biased into a locked position by the spring in which the locks on the foot prevent rotation of the plunger, in accordance with at least one aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DESCRIPTION

Before explaining various aspects of furniture assemblies in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Furniture is often assembled and disassembled by users at least once during its lifetime. Some pieces of furniture may be at least partially disassembled and reassembled multiple times. For example, new furniture may arrive at least partially unassembled, and can require at least some assembly by a user. Additionally, when furniture is moved, at least partial disassembly of the furniture may be necessary or desired because the broken-apart components of the furniture may be lighter and/or less bulky and, thus, may be easier to package, ship, and/or carry, for example.

Assembly, disassembly, and/or re-assembly of the furniture can be toolless and facilitated with clamping and/or locking arrangements that offer robust and secure holds throughout the lifetime of the furniture and/or components thereof.

In certain instances, a locking arrangement can include a spring-loaded detent that is biased into a locked configuration upon assembling the components together, e.g. upon bringing the components into the appropriate proximity in the appropriate sequence and/or direction. A bayonet-type connection can releasably lock the rotatably connected components together, for example. For example, the components can be automatically locked together by a spring-loaded detent upon rotatably coupling the components together. A user can implement an unlocking motion, such as a manual compression of the spring-loaded detent, for example, to unlock the components and allow disassembly, e.g. rotatable decoupling, thereof.

Moreover, a locking arrangement can be incorporated into the furniture components such that it is effectively concealed from view when the components are clamped together and the piece of furniture is fully assembled.

For example, an assembly comprising a furniture leg and a furniture foot can be assembled together and automatically or instantaneously locked into the assembled position with a spring-loaded detent arrangement of the furniture leg and a lock arrangement of the furniture foot. In one instance, the furniture leg can include a plug comprised of a body comprising a cavity, an outer surface, and a guide slot in the outer surface. The plug can also include a spring positioned in the cavity and the detent arrangement, wherein the spring is deformable to move the detent arrangement axially relative to the body. The furniture foot can include a socket comprising a receptacle configured to rotatably receive the plug, a nub extending into the receptacle and configured to move along the guide slot when the receptacle rotatably receives the plug, and a lock. The lock can be configured to, one, move the detent axially between an unlocked position and a locked position when the receptacle rotatably receives the plug and the nub moves along a portion of the guide slot and, two, prevent rotation of the plug relative to the receptacle when the detent is in the locked position and the plug is fully seated in the receptacle.

In certain instances, such a lock can be a dual-purpose or multi-function lock that is configured to move the detent axially between a locked position and an unlocked position and to prevent rotation of the detent, and thus a decoupling rotation of the entire plug of the furniture leg, when the detent is in the locked position.

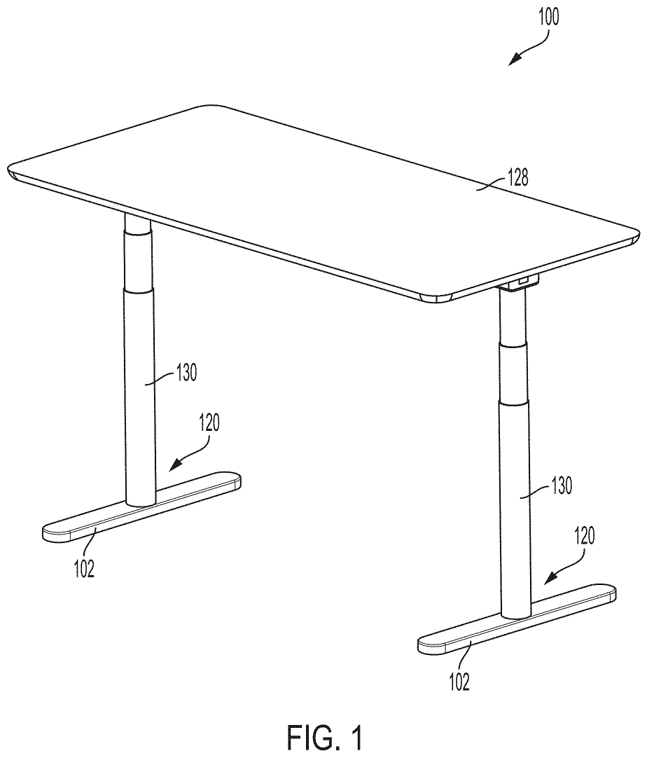

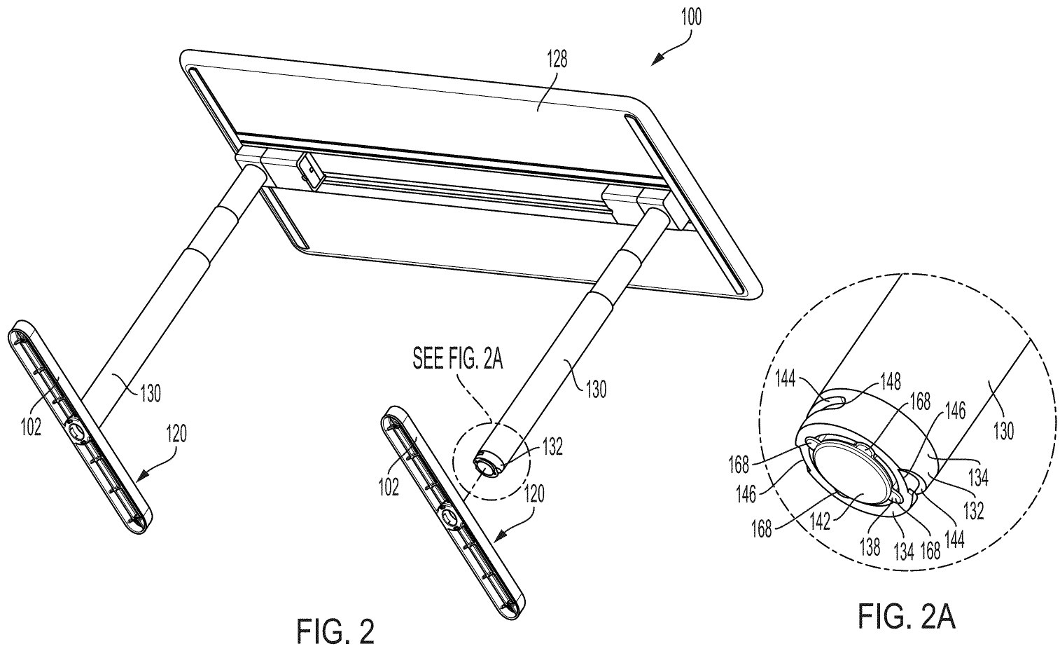

Referring now to FIGS. 1 and 2, a piece of furniture 100 is shown. The piece of furniture 100 includes a tabletop surface 128 and legs 130 supported on feet 102. The feet 102 define an enlarged and elongated end for stabilizing the legs 130. The legs 130 are telescoping legs, which can be adjusted to different heights to raise and/or lower the tabletop surface 128 relative to the feet 102. For example, the piece of furniture 100 can be a desk and/or table that can be converted between a standing-height and a sitting height in certain instances. In other instances, the legs 130 can be a fixed or non-telescoping and the table top surface 128 can be a non-adjustable height.

In various instances, the feet 102 can be referred to as stabilizers and/or the legs 130 can be referred to as pedestals.

A locking arrangement 120 can be configured to lock each foot 102 to the end of a leg 130. The locking arrangement 120 can include a bayonet connection and an interaction of features on the foot 102 (e.g. locks 108 and nubs 110) and the leg 130 (e.g. grooves 144 and detents 168 on a spring-loaded plunger 138), as further described herein.

Although the piece of furniture 100 includes a pair of legs 130 and a pair of feet 102, in other instances, the piece of furniture 100 can include more than two legs 130 and feet 102 or a single leg 130 and a single foot 102.

Though the locking arrangement 120 is shown between a leg 130 and a foot 102, the reader will appreciate that alternative components can be coupled together using the locking arrangement described herein.

The legs 130 and feet 102 can be comprised of metal, such as aluminum or nickel, for example. In certain instances, the tabletop surface 128 can also be comprised of metal and/or can be wood and/or laminate. In other instances, the legs 130, feet 102, and/or tabletop surface 128 can be comprised of a plastic material.

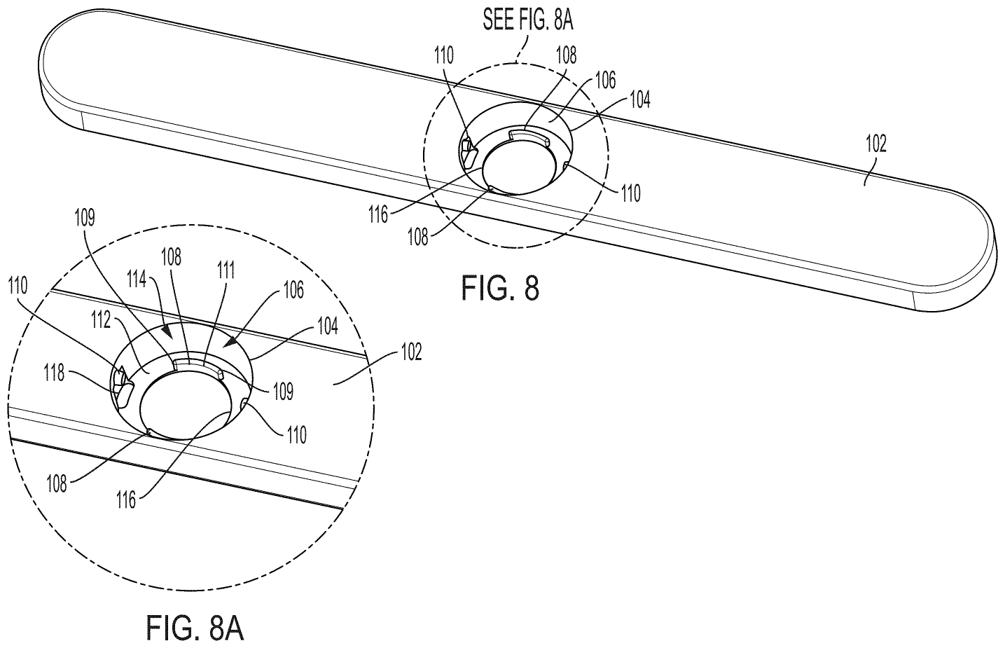

Referring primarily now to FIGS. 2 and 2A, the leg 130 includes a plug 132, which is dimensioned and structured to fit in a socket 104 (see, e.g., FIGS. 8-10) of the foot 102. The plug 132 can be secured to the leg 130 with alignment tabs 156 and/or one of more fasteners (e.g. screws) connecting the plug 132 to the leg 130, for example.

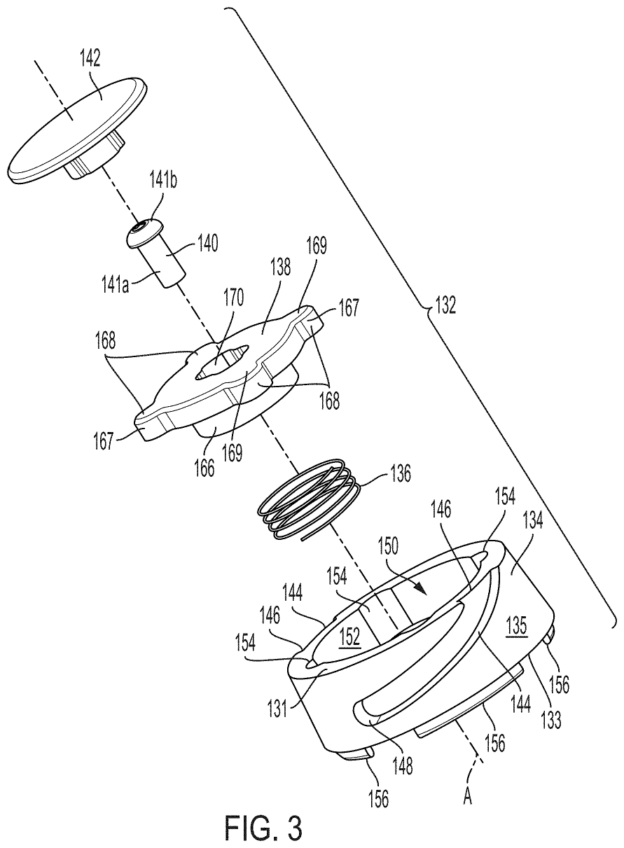

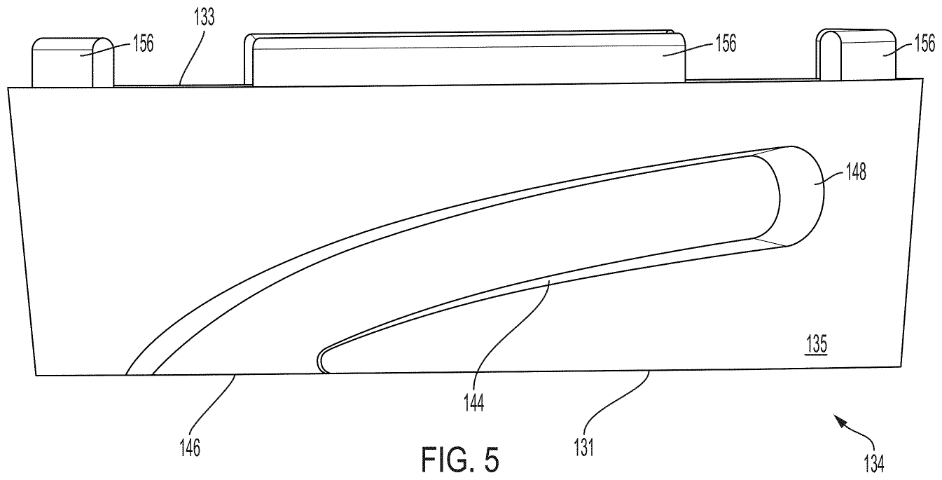

The plug 132 is further depicted in FIGS. 3-7, for example. The plug 132 includes a body 134, a spring 136, a plunger 138, a fastener 140, and an end cap 142. In FIG. 3, the body 134, the spring, 136, the plunger 138, the fastener 140, and the end cap 142 are exploded along a central axis A through the plug 132 and defined by the central axis through a shaft portion 141a of the fastener 140. As further described herein, the plunger 138 is configured to ride along the shaft portion 141a of the fastener 140 between an unlocked position and a locked position, for example.

The body 134 of the plug 132 is tapered forming a truncated conical outer surface 135. A distal end 131 of the body 134, i.e., farther from the leg 130, is narrower than a proximal end 133 of the body 134, i.e., closer to the leg 130. The outer surface 135 of the body 134 has grooves or guide slots 144 defined therein. Each guide slot 144 extends between an entry 146 along the distal end 131 and an end 148 radially offset from the entry 146 around the perimeter of the body 134. The guide slot 144 forms a contoured path between the entry 146 and the end 148. As further described herein, the guide slot 144 is dimensioned and structured to engage the socket 104 to facilitate rotation of the plug 132 within the socket 104 as the plug 132 moves to a fully seated position therein. Stated differently, the guide slot 144 guides the plug 132 further into the socket 104 as the plug 132 rotates.

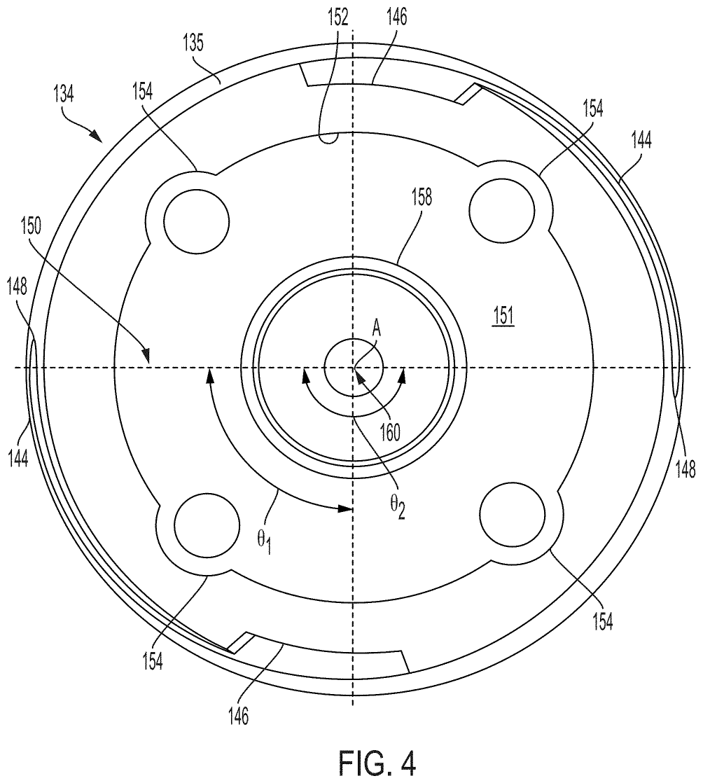

Referring primarily to FIG. 4, the entry 146 is offset from the end 148 by 01, which is ninety degrees in FIG. 4. In such instances, the radial length of the guide slot 144 is ninety degrees. In such instances, the locking arrangement 120 can define a quarter-turn locking arrangement in which a rotation of the plug 132 ninety degrees within the socket 104 effectively locks the plug 132 within the socket 104. Moreover, the body 134 includes a pair of guide slots 144. The guide slots 144 are equidistantly spaced around the perimeter of the body 134. The radial offset between the entries 146 is θ2, which is 180 degrees in FIG. 4. Similarly, the radial offset between the ends 148 is also 180 degrees in FIG. 4. Alternative geometries are contemplated. For example, the body 134 can include a single guide slot or more than two guide slots, for example.

In various instances, the locking arrangement 120 can be less than a quarter-turn locking arrangement and the entry 146 can be radially offset from the end 148 by less than ninety degrees. For example, an eighth-turn locking arrangement can include guide slots having a forty-five-degree arc length. In still other instances, the locking arrangement 120 can be more than a quarter-turn locking arrangement, such as a half-turn locking arrangement, and the entry 146 can be radially offset from the end 148 by more than ninety degrees, e.g. a 180-degree arc length.

The body 134 of the plug 132 includes a central cavity 150 defined by a bottom surface 151 and an inner surface 152. The geometry of the inner surface 152 is configured to prevent rotation of the plunger 138 relative to the body 134 while allowing axial movement of the plunger 138 within the body 134. For example, the inner surface 152 can be cylindrical with a plurality of elongate grooves 154 extending axially along the inner surface 152. Referring to FIG. 4, the elongate grooves 154 extend axially along axes defined into and out of the page and parallel to the central axis A. The grooves 154 are configured to interact with features on the plunger 138 to prevent rotation of the plunger 138 in the central cavity 150 of the body 134.

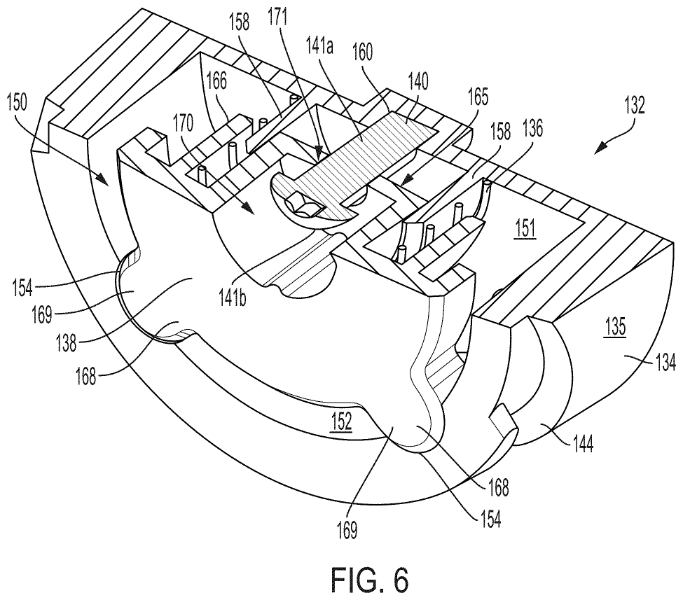

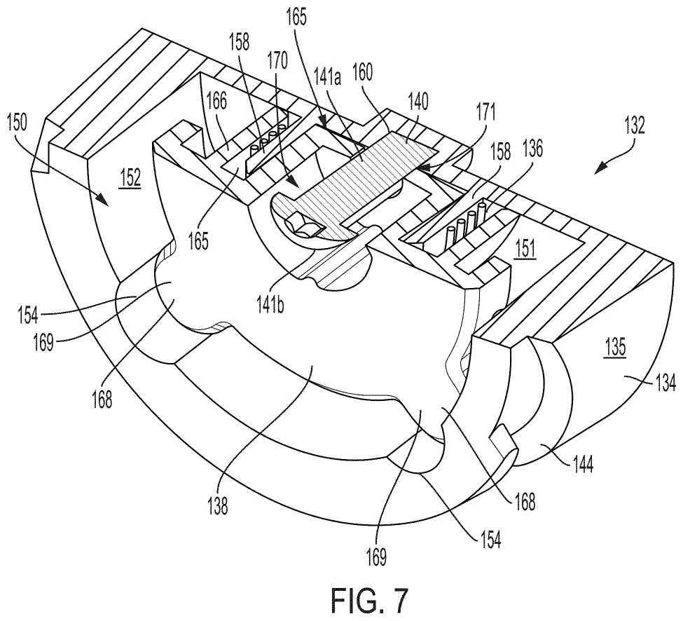

Axial movement of the plunger 138 within the central cavity 150 is permitted by the fastener 140, which includes the shaft portion 141a and a head portion 141b. The shaft portion 141a extends through a through-hole 171 in the plunger 138 and terminates at the bottom surface 151 of the central cavity 150. For example, the end of the shaft portion 141a can be embedded in the bottom surface 151 of the body 134, i.e. positioned in a central recess 160 (see FIGS. 6 and 7) in the bottom surface 151. The enlarged head 141b can be larger than the through-hole 171. The length of the shaft portion 141a intermediate the bottom surface 151 and the enlarged head 141b accommodates a degree of relative axial displacement of the plunger 138 along the shaft portion 141a.

In the depicted instance, the end cap 142 conceals various functional features within the plug 132 such as the fastener 140 and head portion 141b thereof. The end cap 142 also provides a smooth, ergonomic surface for user engagement, such as for a user seeking to release and/or unlock the locking arrangement 120 by pressing on the end cap 142 to compress the plunger 138, as further described herein. The end cap 142 can be snap-fit or friction-fit to the plunger 138. For example, the end cap 142 can include a cylindrical extension configured to frictionally-engage the walls of a cavity 170 in the plunger 138.

The plunger 138 is positioned within the central cavity 150 of the body 134 and is configured to move axially, but not rotatably, relative to the body 134. The plunger 138 can move between an axially-extended position (FIG. 6) and an axially-compressed position (FIG. 7) relative to the body 134. The spring 136 is configured to bias the plunger 138 away from the bottom surface 151 of the body 134 toward the axially-extended position. The spring 136 can be compressed by an external force to move the plunger 138 toward the bottom surface 151 and compress the plunger 138 within the central cavity 150 toward the axially-compressed position.

The plunger 138 includes a detent arrangement of multiple semi-cylindrical protrusions or detents 168, which are configured to fit within the elongate grooves 154 in the body 134. The interaction between the detents 168 and the elongate grooves 154 prevents rotation of the plunger 138 relative to the body 134; however, the detents 168 slide axially within the grooves 154 as the plunger 138 moves between the axially-extended position (FIG. 6) and the axially-compressed position (FIG. 7). In other words, the grooves 154 guide the detents 168 as the plunger 138 is compressed relative to the body 134. The detents 168 each include sidewalls 167 terminating at a top surface 169.

The spring 136 is a compression spring in the form of a coil. The coil twists, spirals and extends around the central axis A (FIG. 3) from a first end adjacent to the plunger 138 to a second end adjacent to the body 134. Referring to FIGS. 6 and 7, the spring 136 is contained between the body 134 and the plunger 138. For example, the body 134 includes a first cylindrical wall 158 and the plunger 138 includes a second cylindrical wall 166. The cylindrical walls 158, 166 can define a space therebetween in which the spring 136 is contained. In certain instances, the first cylindrical wall 158 can be an inner spring-containment wall and the second cylindrical wall 166 can be an outer spring-containment wall. Additionally, the spring 136 is confined between the bottom surface 151 of the body 134 and an underside surface 165 (FIGS. 6 and 7) of the plunger 138. The spring 136 is configured to expand and contract against the limiting surfaces (e.g. the surfaces 151, 158, 165, 166) constraining its travel.

Although a single coil spring 136 is shown, alternative spring geometries and arrangements are contemplated. In certain instances, a plurality of springs can be configured to bias the plunger 138 toward the axially-extended position. Moreover, non-coil springs, such as leaf springs, for example, can be incorporated into the plug 132.

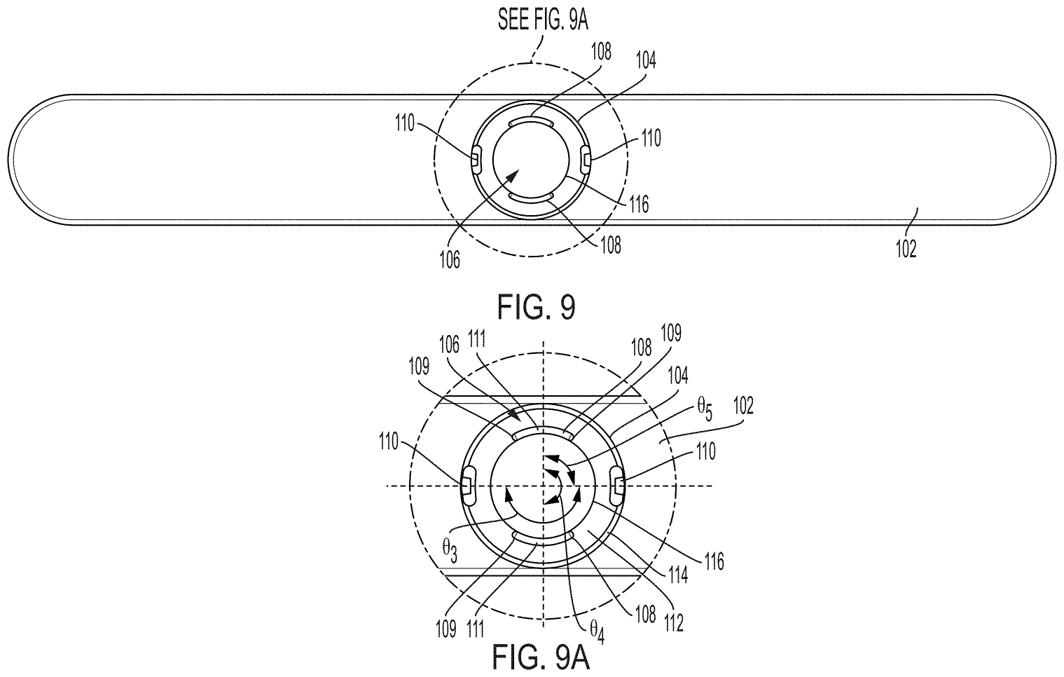

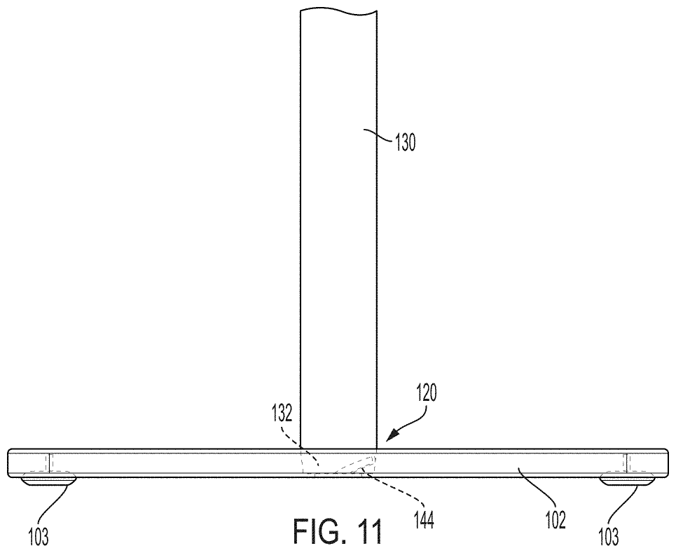

Referring now to FIGS. 8-9A, the foot 102 is shown. The foot 102 defines an elongate body for stabilizing the piece of furniture 100. The foot 102 includes a pair of contacts 103 on either side of the socket 104 (see FIG. 11). The contacts 103 are configured to engage the floor or support surface and, in certain instances, can be adjustable to accommodate uneven flooring or sub-surfaces, for example. In other instances, the foot 102 can include a single point of contact or more than two contacts. For example, the foot 102 can be a polygon, e.g. triangular and/or star-shaped, and can include a contact at each corner and/or vertex.

The socket 104 in the foot 102 forms a receptacle 106, which is dimensioned to rotatably receive the plug 132. The bounding surfaces of the receptacle 106 include a bottom surface 112 and a sidewall 114. The sidewall 114 is tapered and dimensioned to receive the tapered body 134 of the plug 132 therein. A through-hole 116 in the bottom surface 112 is dimensioned and positioned to provide user access to the plunger 138 when the plug 132 is fully seated in the socket 104, such that the user can selectively engage the plunger 138 to unlock the detent arrangement thereof, as further described herein.

The socket 104 also includes at least one lock 108 and at least one pin or nub 110 extending into the receptacle 106. The nubs 110 are cylindrical projections from the sidewall 114. Referring primarily to FIG. 9A, a pair of nubs 110 are radially offset by an angle θ3, which is 180 degrees in FIG. 9A. The radial offset between nubs 110 can correspond to the radial offset between the entries 146 to the guide slots 144. The nubs 110 are configured to be received in the respective guide slots 144 on the plug 132 and are moved along the guide slots 144 from the entry 146 to the end 148 when the receptacle 106 of the socket 104 rotatably receives the plug 132 therein.

In other instances, the reader will appreciate alternative threaded arrangements can be configured to rotatably couple the plug 132 into the receptacle 106 of the socket 104. In certain instances, one or more guide slots can be defined in the sidewalls of the socket 104 and one or more projections or nubs can extend from the plug 132, for example.

In various instances, the foot 102 can be die-cast. The foot 102 includes cutout or openings 118 vertically aligned with each nub 110. The openings 118 are configured to provide the die-cast mold features a through access to the nubs 110 in forming them during the molding process.

During assembly of the plug 132 and the socket 104, the locks 108 are configured to engage the plunger 138 to unlock the plug 132. Moreover, when the plug 132 is fully seated in the socket 104, the locks 108 are configured to lock the plug 132 therein. The locks 108 are cylindrical projections or ridges defining a curve or arc from end-to-end. The locks 108 extend from the bottom surface 112 into the receptacle 106 around the perimeter of the through-hole 116.

The locks 108 define a top surface, or peak, 111 and sidewalls 109 extending vertically from the bottom surface 112 to the top surface 111. The top surface 111 is the farthest portion of the lock 108 from the bottom surface 112. The sidewalls 109 curve between a first side or first end of the lock 108 and a second side or second end of the lock 108.

Referring primarily to FIG. 9A again, the pair of locks 108 are radially offset by an angle θ4, which is 180 degrees in FIG. 9A. Moreover, the locks 108 are equidistantly spaced between the nubs 110 around the perimeter of the socket 104. For example, the center of each lock 108 is radially offset from each nub 110 by an angle θ5, which is ninety degrees in FIG. 9A. The locks 108 define an arc length of approximately 60 degrees, for example. In other instances, the arc length can be less than sixty degrees, e.g. 45 degrees, or more than sixty degrees, e.g. 90 degrees.

The locks 108 are configured to compress the plunger 138 and the spring 136 within the body 134 when the plug 132 rotatably engages the socket 104 and the nubs 110 move along the guide slots 144. More specifically, the top surface 111 of the locks 108 are configured to engage the top surface 169 of the detents 168 on the plunger 138 to push the detents 168 into the central cavity 150 such that the detents 168 are in the axially-compressed configuration, which corresponds to the unlocked position of the plug 132. When the detent 168 is in the locked position and the plug 132 is fully seated in the receptacle, the sidewalls 109 of the locks 108 are configured to prevent rotation of the plug 132 relative to the receptacle 106. More specifically, the locks 108 fit between adjacent detents 168 and the ends of the sidewalls 109 of the lock 108 abut the sidewalls 167 of the detents 168 to prevent rotation of the plug 132 relative to the socket 104.

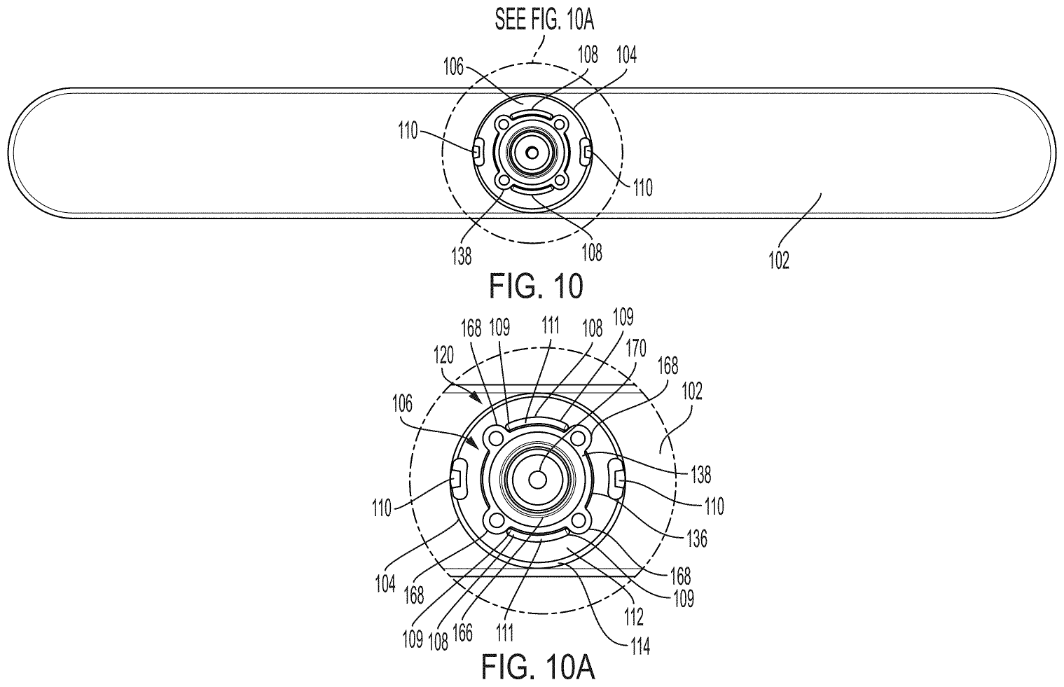

Referring primarily now to FIG. 10A, portions of the plug 132 are shown relative to the socket 104 when the plug 132 is fully seated in the socket 104. In FIG. 10A, the body 134 is hidden to expose the spring 136 and the plunger 138. When the plug 132 is fully seated in the socket 104, the spring 136 is configured to bias the plunger 138 into the axially-expanded configuration, or locked configuration, in which the detents 168 are positioned around the sidewalls 109 of the locks 108. In such a configuration, the sidewalls 167 of the detents 168 abut sidewalls 109 of the locks 108, such that rotation of the plunger 138 (and, thus, the entire plug 132) relative to the socket 104 is constrained. Specifically, rotation of the detents 168 is prevented by the abutting engagement of the locks 108.

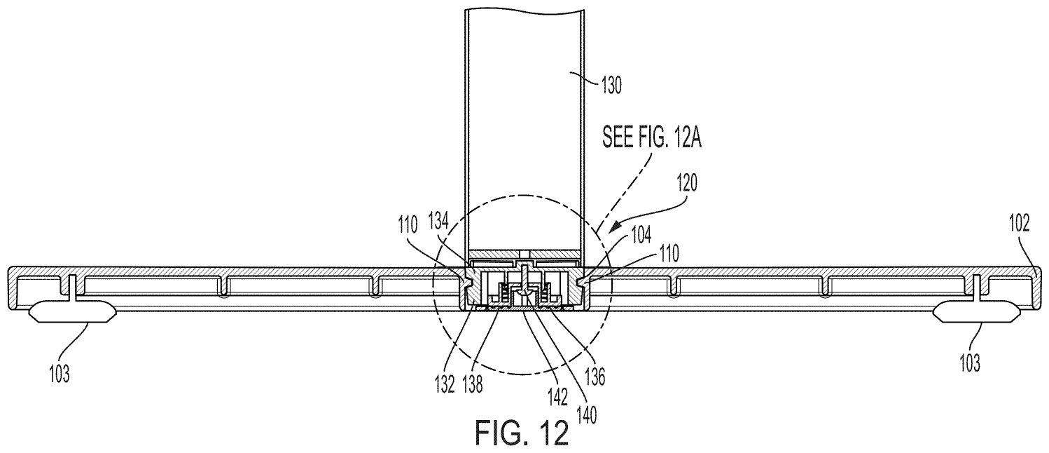

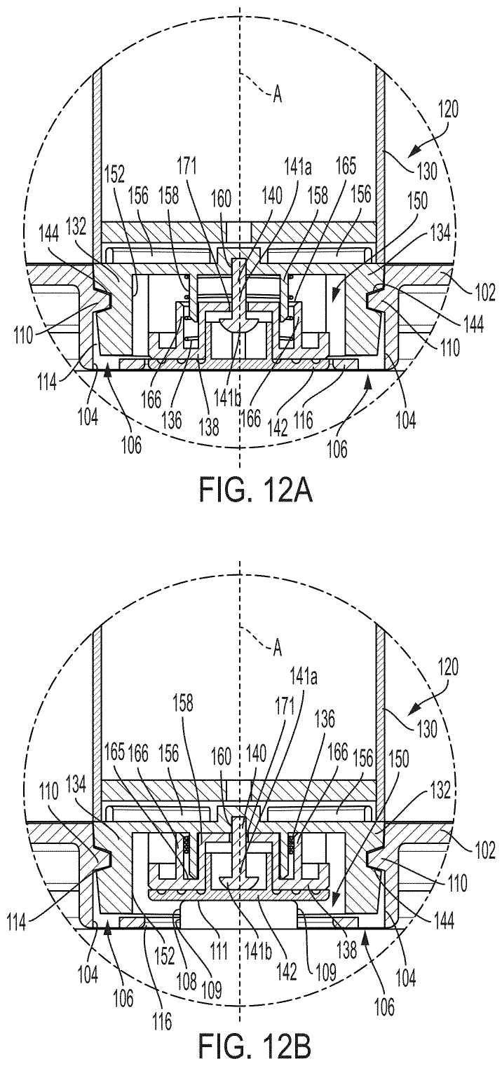

Referring now to FIGS. 11 and 12, the plug 132 is fully seated in the socket 104 and the locking arrangement 120 is configured to hold the plug 132 therein. For example, the locking arrangement 120 prevents rotation of the plug 132 within the socket 104, and thus, the plug 132 cannot be rotatably withdrawn from the socket 104. When fully seated, the nubs 110 are positioned at the ends 148 of the each guide slot 144. Moreover, the locks 108 are radially aligned with the spaces between the detents 168. When the locking arrangement 120 locks the plug 132 within the socket 104, the plunger 138 is in the axially-extended position (FIG. 12A) in which the locks 108 engage the detents 168. To unlock the plug 132 from the socket 104, the plunger 138 can be moved to the axially-compressed position (FIG. 12B), in which the spring 136 is compressed and the detents 168 and end cap 142 are displaced axially to clear the top surface 111 of the locks 108 from the top surface 169 of the detents 168. When the detents 168 are moved axially around the locks 108, the plunger 138 (and thus the entire plug 132) can once again rotate within the socket 104 to withdraw the plug 132 from the socket 104.

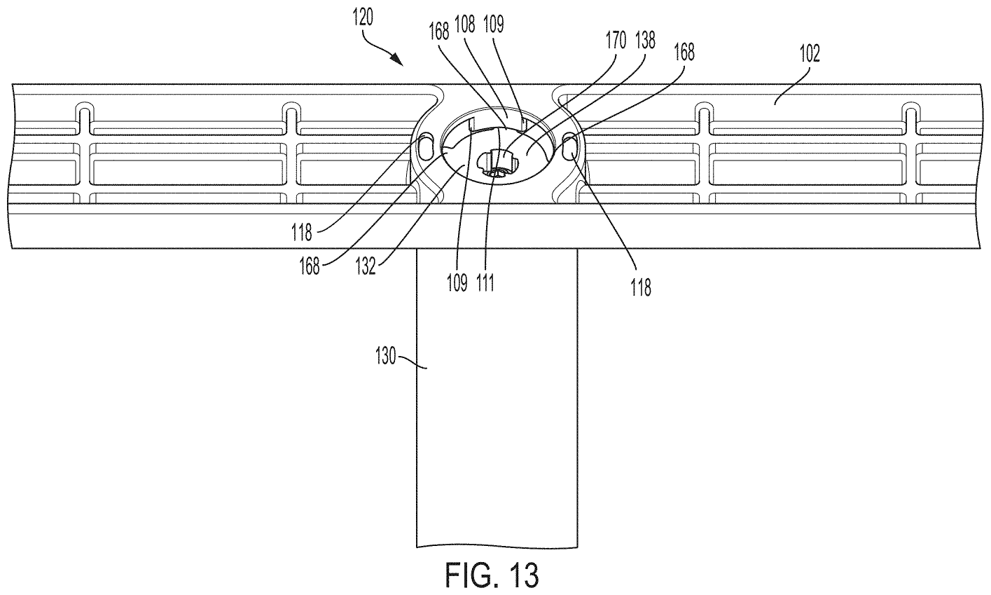

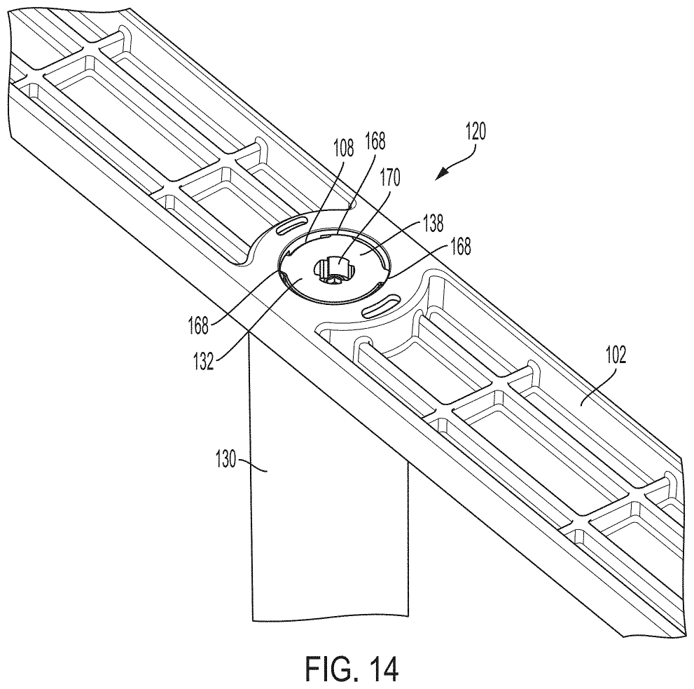

An assembly operation for the leg 130 and the foot 102 are shown in FIGS. 13 and 14. The reader will appreciate that rotation of the foot 102 in the assembly operation of FIGS. 13 and 14 results in the automatic locking or clamping of the foot 102 to the leg 130 via the spring-loaded detents 168 of the plunger 138 relative to the locks 108 of the socket 104. In other words, the locking arrangement 120 automatically snaps or “clicks” into a locked position to hold the plug 132 in the socket 104. To initiate an assembly operation, the nubs 110 are brought into alignment with the entry 146 to their respective guide slots 144 such that the nubs 110 can enter the respective guide slots 144. As the nubs 110 move along their respective guide slots 144, the foot 102 rotates relative to the leg 130 and the lock 108 moves into engagement with the plunger 138 and specifically the detents 168 thereof.

In FIG. 13, the locks 108 are engaged with the detents 168 such that the locks 108 are configured to overcome the spring force from the spring 136 and push the detents 168 downward to compress the plunger 138 into the central cavity 150 of the body 134 of the plug 132. The locks 108 continue to compress the plunger 138 as the nubs 110 move toward the end 148 of the guide slots 144 and the socket 104 rotates about the plug 132. In various instances, the arc length of the locks 108 can be sufficient to engage the detents 168 and push the plunger 138 downward until the plug 132 is fully seated in the socket 104.

In FIG. 14, the plug 132 is fully seated in the socket 104. In various instances, the nubs 110 can reach the end 148 of their respective guide slots 144 when the plug 132 is fully seated in the socket 104. Additionally or alternatively, the locks 108 can move into alignment with the spaces between adjacent detents 168 such that the spring 136 biases the plunger 138 toward the bottom surface 112 when the plug 132 is fully seated in the socket 104. In such instances, further rotation of the socket 104 about the plug 132 is prevented by the spring-loaded detents 168 and the associated locking arrangement 120. In such instances, the plug 132 is instantaneously locked or clamped in the socket 104 upon being fully seated therein. In other words, beyond properly assigning and assembling the components together, no further step is required to lock the components together.

When the plug 132 is locked in the socket 104, as described herein, the plug 132 can remain locked in the socket 104 by the spring-biased detents 168 and the locks 108 until an external force acts upon the plunger 138 to release the spring-loaded detents 168 from the locks 108. For example, referring again to FIG. 12B, a user can push the end cap 142 and, thus, the plunger 138 into the central cavity 150 of the body 134 by applying an axial force along the central axis A to compress the spring 136. Access to the end cap 142 and the plunger 138 can be provided via the through-hole 116 in the bottom surface 112 of the socket 104. Upon compressing the plunger 138 away from the bottom surface 112 and the locks 108 protruding therefrom into the receptacle 106, the plunger 138 and plug 132 can be configured to rotate as the nubs 110 move through the guide slots 144 away from the ends 148 and toward the entries 146 thereof. Upon the nubs 110 exiting the guide slots 144, the plug 132 can be removed from the socket 104.

In various instances, access to the end caps 142 and the plunger 138 is limited by the orientation of the piece of furniture 100. For example, when assembled, the feet 102 rest on a support surface, e.g. a floor, and the through-hole 116 providing access to the end caps 142 and the plunger 138 is adjacent to the support surface. In such instances, the end caps 142 and the plunger 138 face the support surface and are not viewable or easily accessible to the user. As a result, unlocking of the locking arrangement 120 by pushing on the end cap 142 to compress the plunger 138 can be blocked or inhibited when the piece of furniture 100 is fully assembled and properly oriented on the support surface.

The reader will appreciate that alternative arrangements are contemplated in which the end caps are more easily accessible to the user even when the furniture components are completely assembled and properly oriented. For example, a through-hole for accessing the end caps 142 and/or the plunger 138 can be positioned on a back-side and/or underside of the piece of furniture but not against the support surface and/or floor.

### Examples

Example 1—An assembly comprising a first furniture component and a second furniture component. The first furniture component comprises a socket. The socket comprises a receptacle, a lock, and a nub extending into the receptacle. The first furniture component and the second furniture component are movable between an unassembled configuration and an assembled configuration. The second furniture component comprises a plug configured to fit at least partially within the receptacle when the first furniture component and the second furniture component are in the assembled configuration. The plug comprises a body and a spring-loaded plunger. The body comprises a cavity, an outer surface, and a guide slot in the outer surface. The guide slot is configured to receive the nub as the first furniture component and the second furniture component are moved into the assembled configuration. The spring-loaded plunger is configured to fit at least partially within the cavity. The spring-loaded plunger is configured to move axially but not rotatably relative to the body. The lock is configured to compress the spring-loaded plunger within the cavity from a first configuration to a second configuration as the plug rotates within the receptacle and the nub moves along an engagement portion of the guide slot. The lock is configured to release the spring-loaded plunger from the second configuration when the nub moves past the engagement portion of the guide slot. The lock is configured to prevent rotation of the plug relative to the receptacle when the spring-loaded plunger is in the first configuration and the first furniture component and the second furniture component are in the assembled configuration.

Example 2—The assembly of Example 1, wherein the first furniture component comprises a foot, and wherein the second furniture component comprises a leg.

Example 3—The assembly of Examples 1 or 2, wherein the guide slot comprises an entry for the nub, an end radially offset from the entry, and an arced path intermediate the entry and the end.

Example 4—The assembly of Example 3, wherein the entry is radially offset from the end by approximately 90 degrees.

Example 5—The assembly of Examples 1, 2, 3, or 4, wherein the receptacle is defined by a top edge, a bottom surface, and a sidewall between the top edge and the bottom surface, wherein the nub extends into the receptacle from the sidewall, and wherein the lock comprises a ridge extending into the receptacle from the bottom surface.

Example 6—The assembly of Example 5, wherein the sidewall is tapered intermediate the top edge and the bottom surface.

Example 7—The assembly of Examples 1, 2, 3, 4, 5, or 6, wherein the cavity comprises a plurality of elongate grooves, wherein the spring-loaded plunger comprises a plurality of detents, wherein each detent is restrained within one of the elongate grooves to constrain rotation of the spring-loaded plunger relative to the body.

Example 8—The assembly of Example 7, wherein each detent is configured to move axially in one of the elongate grooves as the spring-loaded plunger moves axially relative to the body.

Example 9—The assembly of Examples 7 or 8, wherein the ridge is configured to fit between adjacent detents to release the spring-loaded plunger from the second configuration and hold the spring-loaded plunger in the first configuration.

Example 10—The assembly of Examples 7, 8, or 9, wherein the detents comprise a top surface and sidewalls, wherein the ridge is configured to abut a portion of the top surface to compress the spring-loaded plunger, and wherein the ridge is configured to engage a portion of the sidewalls to resist rotation of the plug relative to the socket when the second furniture component is in the assembled configuration.

Example 11—An assembly comprising a furniture leg and a furniture foot. The furniture leg comprises a plug. The plug comprises a body, a spring, and a detent arrangement. The body comprises a cavity, an outer surface, and a guide slot in the outer surface. The spring is positioned in the cavity. The spring is deformable to move the detent arrangement axially relative to the body. The furniture foot comprises a socket. The socket comprises a receptacle configured to rotatably receive the plug, a nub extending into the receptacle, and a lock. The nub is configured to move along the guide slot when the receptacle rotatably receives the plug. The lock is configured to move the detent arrangement axially between an unlocked position and a locked position when the receptacle rotatably receives the plug and the nub moves along a portion of the guide slot. The lock is further configured to prevent rotation of the plug relative to the receptacle when the detent arrangement is in the locked position and the plug is fully seated in the receptacle.

Example 12—The assembly of Example 11, wherein the lock comprises a ridge extending into the receptacle from a bottom surface of the receptacle.

Example 13—The assembly of Example 12, wherein the detent arrangement comprises a top surface and sidewalls, wherein the ridge is configured to abut a portion of the top surface to compress the spring, and wherein the ridge is configured to engage a portion of the sidewalls to resist rotation of the plug relative to the socket when the plug is fully seated in the receptacle.

Example 14—An assembly comprising a first furniture component and a second furniture component. The first furniture component comprises a spring-loaded detent. The spring-loaded detent is biased axially along a central axis toward a locked configuration. The second furniture component comprises a lock arrangement. The first furniture component and the second furniture component are rotatably connected about the central axis through a rotary range of motion. The lock arrangement is configured to move the spring-loaded detent from the locked configuration to an unlocked configuration during the rotary range of motion, release the spring-loaded detent from the unlocked configuration after the rotary range of motion, and prevent rotation of the spring-loaded detent in the locked configuration after the rotary range of motion.

Example 15—The assembly of Example 14, wherein the first furniture component comprises a leg, and wherein the second furniture component comprises a foot.

Example 16—The assembly of Examples 14 or 15, wherein the first furniture component comprises a plug, and wherein the second furniture component comprises a socket.

Example 17—The assembly of Example 16, wherein the lock arrangement comprises an axial protrusion extending into the socket.

Example 18—The assembly of Examples 14, 15, 16, or 17, wherein the spring-loaded detent comprises a radial protrusion.

Example 19—The assembly of Examples 14, 15, 16, 17, or 18, wherein the rotary range of motion defines a quarter-turn rotation.

Example 20—The assembly of Examples 14, 15, 16, 17, 18, or 19, wherein the first furniture component comprises a radial guide path defining an arc length, and wherein the second furniture component comprises a nub configured to move along the radial guide path during the rotary range of motion.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

It will be further appreciated that, for convenience and clarity, spatial terms such as “vertical”, “horizontal”, “up”, and “down” may be used herein with respect to the drawings. However, furniture can be positioned in many orientations and positions, and these terms are not intended to be limiting and/or absolute.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may sometimes be performed in any order. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. An assembly, comprising:
a first furniture component comprising a socket, wherein the socket comprises:
a receptacle;
a lock; and
a nub extending into the receptacle; and
a second furniture component, wherein the first furniture component and the second furniture component are movable between an unassembled configuration and an assembled configuration, wherein the second furniture component comprises a plug configured to fit at least partially within the receptacle when the first furniture component and the second furniture component are in the assembled configuration, and wherein the plug comprises:
a body comprising a cavity, an outer surface, and a guide slot in the outer surface, wherein the guide slot is configured to receive the nub as the first furniture component and the second furniture component are moved into the assembled configuration; and
a spring-loaded plunger configured to fit at least partially within the cavity, wherein the spring-loaded plunger is configured to move axially but not rotatably relative to the body;
wherein the lock is configured to compress the spring-loaded plunger within the cavity from an axially-extended position to an axially-compressed position as the plug rotates within the receptacle and the nub moves along an engagement portion of the guide slot, wherein the lock is configured to release the spring-loaded plunger from the axially-compressed position when the nub moves past the engagement portion of the guide slot, and wherein the lock is configured to prevent rotation of the plug relative to the receptacle when the spring-loaded plunger is in the axially-extended position and the first furniture component and the second furniture component are in the assembled configuration.

2. The assembly of claim 1, wherein the first furniture component comprises a foot, and wherein the second furniture component comprises a leg.

3. The assembly of claim 1, wherein the guide slot comprises an entry for the nub, an end radially offset from the entry, and an arced path intermediate the entry and the end.

4. The assembly of claim 3, wherein the entry is radially offset from the end by approximately 90 degrees.

5. The assembly of claim 1, wherein the receptacle is defined by a top edge, a bottom surface, and a sidewall between the top edge and the bottom surface, wherein the nub extends into the receptacle from the sidewall, and wherein the lock comprises a ridge extending into the receptacle from the bottom surface.

6. The assembly of claim 5, wherein the sidewall is tapered intermediate the top edge and the bottom surface.

7. The assembly of claim 5, wherein the cavity comprises a plurality of elongate grooves, wherein the spring-loaded plunger comprises a plurality of detents, wherein each detent is restrained within one of the elongate grooves to constrain rotation of the spring-loaded plunger relative to the body.

8. The assembly of claim 7, wherein each detent is configured to move axially in one of the elongate grooves as the spring-loaded plunger moves axially relative to the body.

9. The assembly of claim 8, wherein the ridge is configured to fit between adjacent detents to release the spring-loaded plunger from the axially-compressed position and hold the spring-loaded plunger in the axially-extended position.

10. The assembly of claim 9, wherein the detents comprise a top surface and sidewalls, wherein the ridge is configured to abut a portion of the top surface to compress the spring-loaded plunger, and wherein the ridge is configured to engage a portion of the sidewalls to resist rotation of the plug relative to the socket when the second furniture component is in the assembled configuration.

11. An assembly, comprising:
a furniture leg comprising a plug, wherein the plug comprises:
a body comprising a cavity, an outer surface, and a guide slot in the outer surface;
a spring positioned in the cavity; and
a detent arrangement, wherein the spring is deformable to move the detent arrangement axially relative to the body; and
a furniture foot comprising a socket, wherein the socket comprises:
a receptacle configured to rotatably receive the plug;
a nub extending into the receptacle, wherein the nub is configured to move along the guide slot when the receptacle rotatably receives the plug; and
a lock configured to:
move the detent arrangement axially from a locked position toward an unlocked position when the receptacle rotatably receives the plug and the nub moves along a portion of the guide slot, wherein the spring is further compressed within the cavity as the detent arrangement moves toward the unlocked position; and
prevent rotation of the plug relative to the receptacle when the detent arrangement is in the locked position and the plug is fully seated in the receptacle.

12. The assembly of claim 11, wherein the lock comprises a ridge extending into the receptacle from a bottom surface of the receptacle.

13. The assembly of claim 12, wherein the detent arrangement comprises a top surface and sidewalls, wherein the ridge is configured to abut a portion of the top surface to compress the spring, and wherein the ridge is configured to engage a portion of the sidewalls to resist rotation of the plug relative to the socket when the plug is fully seated in the receptacle.

14. An assembly, comprising:
a first furniture component comprising a spring-loaded detent, wherein the spring-loaded detent is biased axially along a central axis toward a locked configuration; and
a second furniture component comprising a lock arrangement;
wherein the first furniture component and the second furniture component are rotatably connected about the central axis through a rotary range of motion;
wherein the lock arrangement is configured to:
move the spring-loaded detent from the locked configuration to an unlocked configuration during the rotary range of motion;
release the spring-loaded detent from the unlocked configuration after the rotary range of motion; and
prevent rotation of the spring-loaded detent in the locked configuration after the rotary range of motion.

15. The assembly of claim 14, wherein the first furniture component comprises a leg, and wherein the second furniture component comprises a foot.

16. The assembly of claim 14, wherein the first furniture component comprises a plug, and wherein the second furniture component comprises a socket.

17. The assembly of claim 16, wherein the lock arrangement comprises an axial protrusion extending into the socket.

18. The assembly of claim 17, wherein the spring-loaded detent comprises a radial protrusion.

19. The assembly of claim 18, wherein the rotary range of motion defines a quarter-turn rotation.

20. The assembly of claim 19, wherein the first furniture component comprises a radial guide path defining an arc length, and wherein the second furniture component comprises a nub configured to move along the radial guide path during the rotary range of motion.
